(19) United States
(12) Patent Application Publication
(10) Pub. No.: US 2016/0354861 A1
(43) Pub. Date: Dec. 8, 2016

(54) MODIFYING METAL OR ALLOY SUBSTRATES

(71) Applicant: Rolls-Royce Corporation, Indianapolis, IN (US)

(72) Inventors: Raymond Ruiwen Xu, Carmel, IN (US); Robert F. Proctor, Carmel, IN (US)

(21) Appl. No.: 15/150,969

(22) Filed: May 10, 2016

Related U.S. Application Data
(60) Provisional application No. 62/172,518, filed on Jun. 8, 2015.

(51) Int. Cl. B23K 20/12

(52) U.S. Cl. CPC B23K 20/1275; C22C 38/54

(57) ABSTRACT

Example techniques include contacting a surface of a substrate including a metal or alloy with a rotating friction stir tool, and penetrating at least a portion of the rotating friction stir tool to a predetermined depth below the surface while rotating to agitate a stir region below the surface. The agitating modifies an average grain size of the metal or alloy in the stir region and an average grain size of the metal or alloy in a second region outside of and adjacent to the stir region compared to an average grain size of the metal or alloy outside of the stir region and the second region to modify a microhardness of the metal or alloy in the stir region and a microhardness of the metal or alloy in the second region compared to a microhardness of the metal or alloy outside of the stir region and the second region.

This application claims the benefit of U.S. Provisional Application No. 62/172,518 filed Jun. 8, 2015, which is incorporated herein by reference in its entirety.

### TECHNICAL FIELD

The disclosure relates to modification, joining, or welding of metal or alloy substrates.

### BACKGROUND

Solid-state processes for modifying substrates may be desirable alternatives to fusion-based processes that utilize melting of the substrate being processed. Solid-state processes include friction-based processes and can generate frictional heat that can soften substrates without melting them. Friction stir processes are solid-state processes that employ a rotating tool to press against metal or alloy substrates to modify, weld, or join the substrates.

### SUMMARY

In some examples, the disclosure describes an example technique including contacting a surface of a substrate including a metal or alloy with a rotating friction stir tool, and penetrating at least a portion of the rotating friction stir tool to a predetermined depth below the surface while rotating to agitate a stir region below the surface. The agitating modifies an average grain size of the metal or alloy in the stir region and an average grain size of the metal or alloy in a second region outside of and adjacent to the stir region compared to an average grain size of the metal or alloy outside of the stir region and the second region to modify a microhardness of the metal or alloy in the stir region and a microhardness of the metal or alloy in the second region compared to a microhardness of the metal or alloy outside of the stir region and the second region.

In some examples, the disclosure describes an example article including iron-based alloy substrate. In some examples, the iron-based alloy substrate includes between about 24% and about 27% by weight of nickel, between about 13.5% and 16% by weight of chromium, between about 1% and about 1.5% by weight of molybdenum, between about 1.9% and about 2.35% by weight of titanium, between about 0.1% and about 0.5% by weight of vanadium, between about 0.003% and about 0.01% by weight of boron, up to about 0.08% by weight of carbon, up to about 2% by weight of manganese, up to about 1% by weight of silicon, up to about 0.025% by weight of phosphorus, up to about 0.025% by weight of sulfur, up to about 0.35% by weight of aluminum, and a balance of iron. The iron-based alloy substrate includes a friction stir processed region. In some examples, the friction stir processed region includes a stir region and a second region outside of and adjacent to the stir region. In some examples, a first average grain size in the stir region and a second average grain size in the second region are modified compared to a pre-friction stir average grain size of the iron-based alloy substrate. In some examples, a first microhardness in the stir region and a second microhardness in the second region are modified compared to a pre-friction stir microhardness of the iron-based alloy substrate.

In some examples, the disclosure describes a computer readable storage medium including instructions that, when executed, cause at least one processor to control a friction stir tool to contact a surface of substrate including a metal or alloy, and rotate. In some examples, the at least one processor controls the friction stir tool to penetrate at least a portion of the friction stir tool below the surface to a predetermined depth while rotating to agitate a stir region below the surface. In some examples, the agitating modifies an average grain size of the metal or alloy in the stir region and an average grain size of the metal or alloy in a second region outside of and adjacent to the stir region compared to an average grain size of the metal or alloy substrate outside of the stir region and the second region. In some examples, the agitating modifies a microhardness of the metal or alloy substrate in the stir region and a microhardness of the metal or alloy substrate in the second region compared to a microhardness of the metal or alloy substrate outside of the stir region and the second region.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual and schematic block diagram illustrating an example friction stir processing system including a friction stir tool for processing an alloy or metal substrate.

FIG. 2 is a flow diagram illustrating an example technique for friction stir processing.

FIGS. 3A-3D are conceptual and schematic block diagrams illustrating example friction stir processing systems including a friction stir tool.

FIG. 4 is a chart illustrating example stress-strain curves of an example metal or alloy substrate before and after an example friction stir processing technique.

### DETAILED DESCRIPTION

The disclosure describes example systems and techniques for friction stir processing of a substrate including a metal or alloy to modify properties of the metal or alloy, and articles including friction stir processed metal or alloys. In this disclosure, the term “friction stir processing” includes friction stir welding (FSW), friction stir spot welding (FSSW), friction stir spot joining (FSSJ), friction bit joining (FBJ), friction stir fabrication (FSF), friction stir mixing (FSM), or any other form of friction stir processing (FSP) generally including contacting a substrate with a friction stir tool. Thus, example friction stir processing systems described herein may also be used to fabricate articles by welding or joining substrates. Example friction stir processing techniques described herein may be used to process alloys that may be difficult to process by other techniques, including iron-based or nickel-based alloys, such as austenitic alloys including precipitation strengthened austenitic steel. Example friction stir processing systems described herein may also be used to repair articles by processing, welding, or joining substrates.

Some example techniques according to the disclosure include contacting a surface of the substrate with a rotating friction stir tool. When the friction stir tool contacts the surface of the substrate, at least a portion of the rotating friction stir tool penetrates the substrate to a predetermined depth below the surface while rotating to agitate a stir region below the surface. In addition to affecting microstructure and resulting properties of the stir region, friction stir processing described herein may affect microstructure and resulting properties of at least one region adjacent to and outside of the stir region. For example, as friction stir processing agitates the stir region, adjacent regions of the metal or alloy may experience thermomechanical or thermal cycling. This thermomechanical or thermal cycling may affect a microstructure of the metal or alloy in adjacent regions of the metal or alloy, for example, reducing an average grain size of the metal or alloy in the adjacent region compared to the average grain size before friction stir processing, resulting in a more uniform grain size in the adjacent region compared to the grain size distribution before friction stir processing, or the like. Example friction stir processing techniques described herein may reduce or substantially prevent problems associated with fusion welding or other melting-based techniques, including shrinkage, solidification, cracking and distortion. Further, metals and alloys processed by example friction processing techniques described herein may exhibit improvement in mechanical properties, for example, material microhardness and wear resistance due at least in part to the changes in microstructure of the friction-stir-processed metal or alloy. Some example friction stir processing techniques described herein may increase a microhardness, decrease an average grain size, or both within a stir region and a second region outside and adjacent to the stir region within a metal or alloy, for instance, within austenitic superalloy A286.

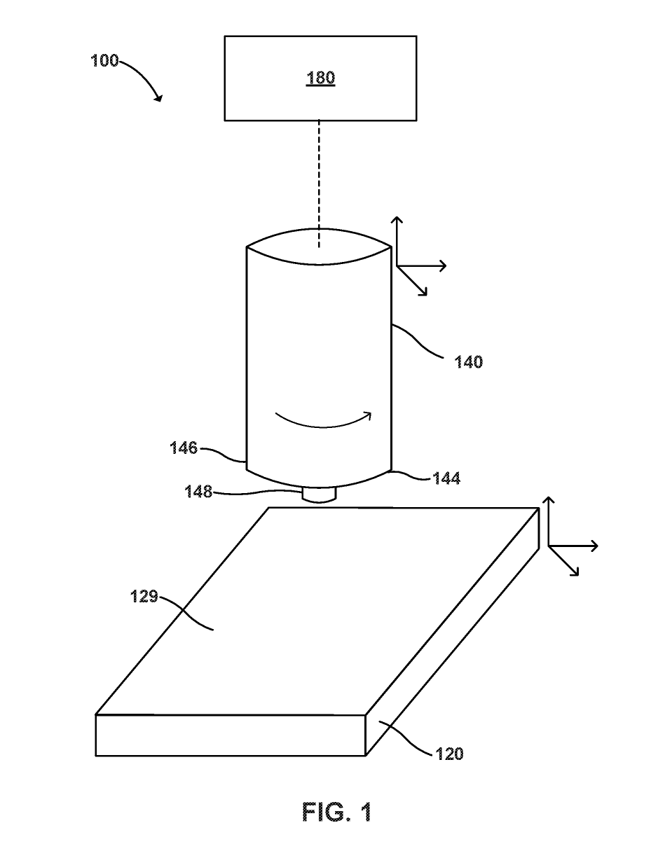

FIG. 1 is a conceptual and schematic block diagram illustrating an example friction stir processing system 100 including a friction stir tool 140 for processing a substrate 120. Substrate 120 includes a metal or alloy. Although substrate 120 is illustrated in FIG. 1 as including a flat surface, in other examples, substrate 120 may include a curved surface, an irregular surface, or a complex surface including one or more of a flat portion, a curved portion, or an irregular portion. Substrate 120 may include any suitable shape, including a sheet or a layer.

In some examples, substrate 120 includes an iron-based or a nickel-based alloy, such as an iron-based superalloy or a nickel-based superalloy. In some examples, substrate 120 includes an austenitic phase constitution. For example, substrate 120 may include austenitic steel, such as A286 alloy, also known as SAE AMS 5525, UNS (Unified Numbering System) S66286, or W. Nr. (Werkstoffnummer) 1.4980. A286 alloy is an iron-based alloy including between about 24% and about 27% by weight of nickel, between about 13.5% and 16% by weight of chromium, between about 1% and about 1.5% by weight of molybdenum, between about 1.9% and about 2.35% by weight of titanium, between about 0.1% and about 0.5% by weight of vanadium, between about 0.003% and about 0.01% by weight of boron, up to about 0.08% by weight of carbon, up to about 2.00% by weight of manganese, up to about 1.00% by weight of silicon, up to about 0.025% by weight of phosphorus, up to about 0.025% by weight of sulfur, up to about 0.35% by weight of aluminum, and the substantial balance of iron. In some examples, A286 alloy includes each of carbon, manganese, silicon, phosphorus, sulfur, and aluminum, and may include greater than 0% and up to the weight percentages listed above for the respective elements (carbon, manganese, silicon, phosphorus, sulfur, and aluminum).

In some examples, the metal or alloy in substrate 120 has an initial microstructure (before friction stir processing), including at least one of an initial grain structure, an initial precipitate structure, and an initial phase constitution. Properties of the metal or alloy in substrate 120, including ductility, malleability, and microhardness, may directly or indirectly depend on the microstructure of the metal or alloy. As used herein, the microstructure refers to the microscopic structure of a metal or alloy that may include at least one of the grain structure, the precipitate structure, and the phase constitution. The grain structure may refer to the arrangement of grains, with areas between grains forming grain boundaries. Each grain within the grain structure of a metal or alloy is a distinct crystal with a specific orientation and may form as a result of solidification or phase transformation. The grain structure also may refer to an average size and size distribution of the grains of the metal or alloy. The precipitate structure may refer to precipitate domains, for instance, through precipitation of different phases, at grain boundaries or within grains of other material. The phase constitution may refer to the allotropic or crystalline phases present within the metal or alloy. In some examples, the microstructure may refer to the at least one of grain structure, precipitate structure, or phase constitution observable at length scales on the order of tenths, one, tens, or hundreds of micrometers (e.g., about 0.1 micrometer to about 1000 micrometers).

As friction stir processing system 100 processes substrate 120 including a metal or alloy, the microstructure in the friction-stir-processed region may change as a result of at least one of mechanical deformation (e.g., plastic deformation), or thermomechanical cycling, or thermal cycling. As examples, grain structure may change by grain refining (for example, reduction in average grain size), the precipitate structure may change, for instance, by precipitate coarsening or dissolving, or the phase may change by phase transformation. Thus, friction stir processing system 100 may change properties of the metal or alloy in the friction-stir-processed region of substrate 120. For instance, a microhardness of a metal or alloy in the friction-stir-processed region of substrate 120 may be changed. Microhardness, also known as microindentation hardness, measures hardness on a microscopic scale, and may be measured by the Vickers hardness test or the Knoop hardness test in some examples.

Thus, in some examples, before substrate 120 is processed by friction stir processing system 100, substrate 120 may have pre-friction stir properties including at least one of grain structure, precipitate structure, phase constitution, and microhardness. The properties may be substantially equal throughout substrate 120, or may vary throughout substrate 120, e.g., due to mechanical working, heat treatments, thermomechanical processing, or the like. As will be described herein, friction stir processing of a region of substrate 120 may result in a difference in at least one property in a friction-stir-processed region compared to a corresponding at least one pre-friction stir properties in the friction-stir-processed region, a difference in at least one property in the friction-stir-processed region compared to a corresponding at least one property outside of the friction-stir-processed region. Further, in some examples, friction stir processing of a region of substrate 120 may result in different properties within subregions of the friction-stir-processed region, and the properties within the subregions may be different than corresponding properties outside of the friction stir processed region.

These changes in at least one property may occur when friction stir tool 140 contacts substrate 120 and penetrates substrate 120 to a predetermined depth while rotating. Friction stir tool 140 includes a working end 144 including a shoulder 146 and a portion that penetrates substrate 120, for instance, a probe 148, as shown in FIG. 1. In other examples, friction stir tool 140 may not include probe 148, and shoulder 146 may include or define at least one groove, peak, or other structure that generates rotational frictional heat when contacting a surface of substrate 120. The at least one groove, peak, may include etchings, raised features, depressed features, grooves, pins, or other structures that generate frictional heat when rotating friction stir tool 140 contacts to soften substrate 120 and allow at least a portion of friction stir tool 140 to penetrate a surface of substrate 120. While example techniques below are described with reference to probe 148, it should be understood that example systems may include probeless or pinless friction stir tools, and that example techniques may be modified so that working end 144 of friction stir tool 140 performs functions performed by one or more of shoulder 146 or probe 148.

In some examples, shoulder 146 may extend from an outer edge of the working end of friction stir tool 140 to an outer edge of probe 148. Shoulder 146 may have a flat surface, a curved surface, a grooved surface, a conical surface, or any other suitable surface that may help manage the distribution of one or both of material or heat in the vicinity of friction stir tool 140.

Probe 148 projects from the working end of friction stir tool 140 as seen in FIG. 1. In some examples, probe 148 includes a single unitary structure, for instance, a pin, a cylinder, a cone, or other protruding structure centered at the center of working end 144. In other examples, probe 148 includes a plurality of distinct probe elements, for instance, more than one pin, cylinder, cone, or other protruding structure that may be symmetrically or asymmetrically disposed about the center of working end 144. In some examples, the rotational center of probe 148 is substantially aligned with the rotational center of friction stir tool 140. Probe 148 rotates with the same rotational speed as friction stir tool 140 when friction stir tool 140 rotates, and generates frictional heat while contacting a surface of a substrate.

In some examples, shoulder 146 and probe 148 are integrally fabricated with friction stir tool 140. In other examples, one or both of shoulder 146 and 148 may be distinct components that are joined or assembled with a tool base to form friction stir tool 140. Friction stir tool 140 may be fabricated to withstand friction generated by contact of rotating friction stir tool 140 with the surface of substrate 120 without being consumed. Therefore, in some examples, friction stir tool 140 includes a substantially non-consumable or substantially non-wearing body that does not significantly wear when contacting substrate 120. In some examples, friction stir tool 140 may include one or more of a metal, an alloy, ceramics, or other materials that are capable of generating frictional heat when rotating friction stir tool 140 contacts a surface of substrate 120, while remaining substantially unconsumed. In some examples, friction stir tool 140, including probe 148, shoulder 146, or both, may include one or more of polycrystalline diamond (PCD), polycrystalline cubic boron nitride (PCBN), tungsten carbide, or steel, for instance, AISI (American Iron and Steel Institute) H13 tool steel.

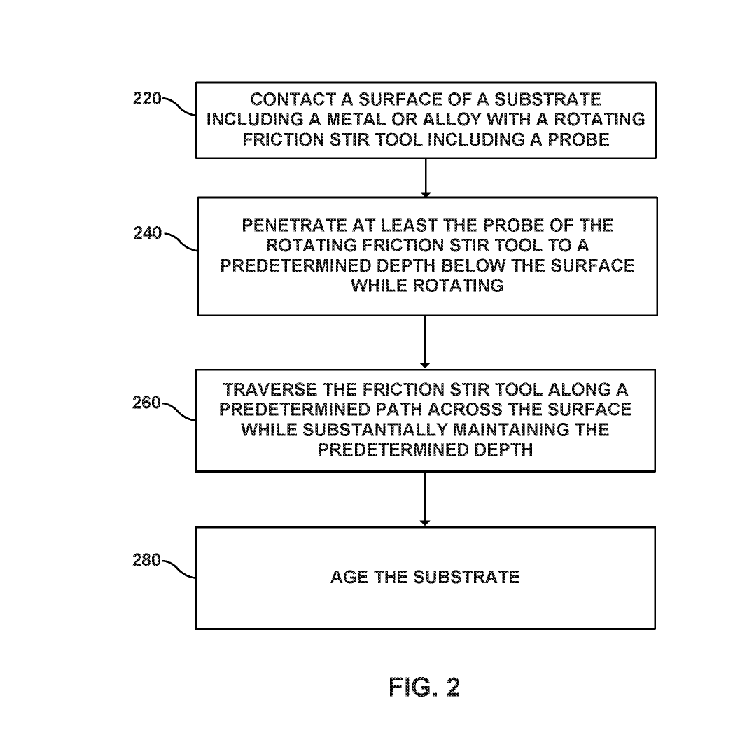

In some examples, friction stir processing system 100 includes a computing device 180. Therefore, in some examples, computing device 180 may control at least one of a rotational speed of friction stir tool 140, displacement of friction stir tool 140 with respect to substrate 120 in one or more dimensions, tilt or inclination of friction stir tool 140, and a contact force or pressure with which friction stir tool 140 contacts, penetrates, or both substrate 120. Computing device 180 includes at least one processor capable of executing instructions. The at least one processor of computing device 180 may execute example techniques described below with reference to FIG. 2. In some examples, the functions attributed to computing device 180 may be distributed over one or more devices, such as, in some examples, a general purpose computing device and a controller for controlling friction stir tool 140, rather than all being performed by one device.

System 100 can be used to friction stir process substrate 120, and may also be used to fabricate articles by welding or joining substrate 120 to other substrates. In some examples, substrate 120 may include a metal or alloy that may be difficult to process by other techniques, including iron-based or nickel-based alloys, such as austenitic alloys including precipitation strengthened austenitic steel, for example, A286 steel. Friction stir processing by system 100 of the metal or alloy in substrate 120 may affect a microstructure of the metal or alloy, for example, modifying an average grain size, affecting properties such as microhardness. The metal or alloy in substrate 120 processed by system 100 may exhibit improvement in mechanical properties, for example, material microhardness and wear resistance due at least in part to the changes in microstructure. System 100 may process the metal or alloy in substrate 120 to increase a microhardness, decrease an average grain size, or both, within stir region 122, and the second region outside and adjacent to stir region 122. Example techniques for friction stir processing that may be implemented using system 100 or other example systems are described below.

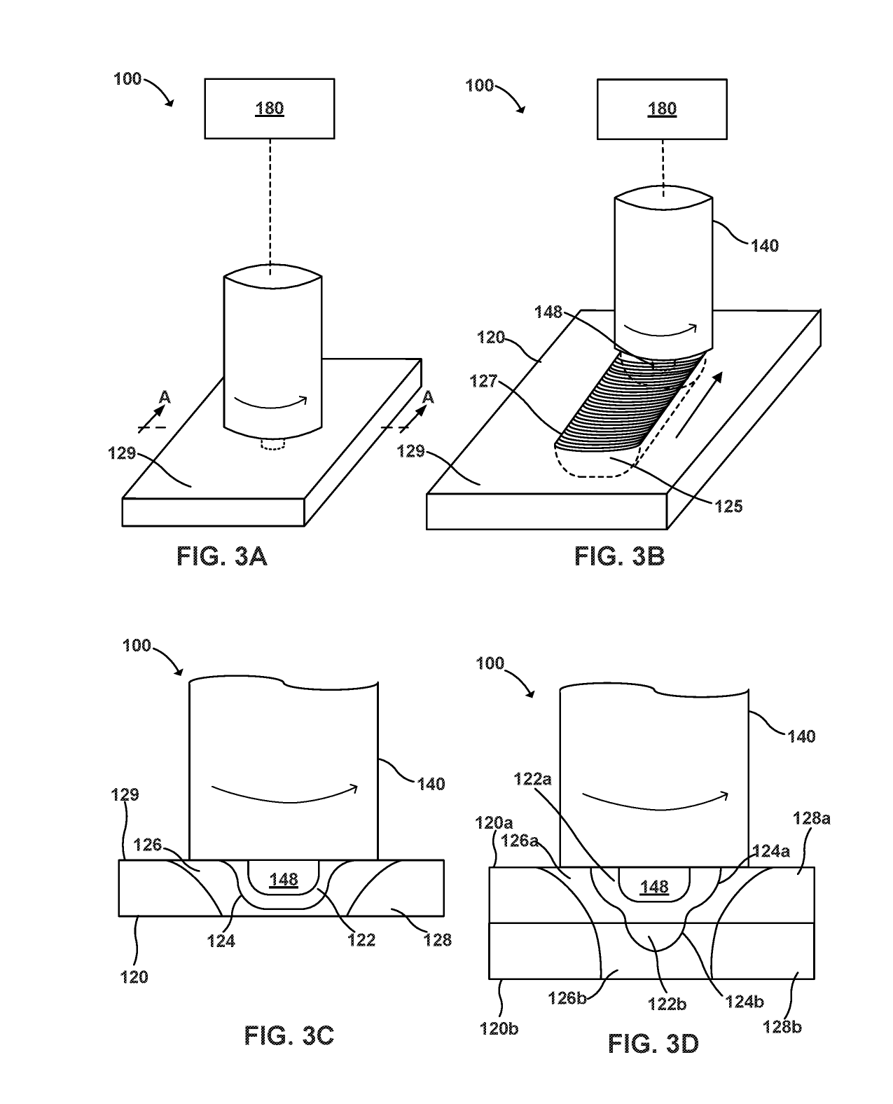

FIG. 2 is a flow diagram illustrating an example technique for friction stir processing. The technique of FIG. 2 will be described with reference to friction stir processing system 100 of FIG. 1 and the conceptual and schematic block diagrams of FIGS. 3A-3D for purposes of illustration. It will be understood that the technique of FIG. 2 may be performed using a different system than friction stir processing system 100 of FIG. 1, friction stir processing system 100 may perform a technique other than that illustrated in FIG. 2, or both. FIGS. 3A-3D are conceptual and schematic block diagrams illustrating example friction stir processing systems 100 including a friction stir tool 140.

In some examples, the technique of FIG. 2 includes contacting a surface 129 of substrate 120, which includes a metal or alloy, with rotating friction stir tool 140 (220). When friction stir tool 140 rotates with a sufficiently high rotational speed, contact between working end 144 of friction stir tool 140 and surface 129 of substrate 120 results in generation of frictional heat (220). In some examples, contacting includes contacting at least shoulder 146 with the surface of substrate 120 (220). In some examples, contacting surface 129 with friction stir tool 140 (220) includes contacting at least probe 148 with surface 129. The heat and rotational forces may result in an initiation of plastic deformation at surface 129 of substrate 120, allowing probe 148 to penetrate surface 129 of substrate 120 (240). In some examples, at least a portion of friction stir tool 140, such as probe 148, shoulder 146, or working end 144 may penetrate substrate 120 to a predetermined depth below surface 129 while friction stir tool 140 rotates to agitate a stir region 122 within substrate 120, as seen in FIG. 3A (240). In some examples, the predetermined depth may be at least partially defined by the length that probe 148 extends from shoulder 146, as friction stir tool 140 may be advanced until shoulder 146 contacts surface 129 and substantially all (e.g., all or nearly all) the length of probe 148 penetrates into substrate 120. Hence, the length of probe 148 may be selected based at least in part on the desired depth of penetration into substrate 120.

In some examples, the predetermined depth may be less than the thickness of substrate 120, such as between about 50% and about 90% of the thickness of substrate 120. In some examples, the predetermined depth may be more than the depth of substrate 120, for instance, if there is another substrate below substrate 120.

In some examples, computing device 180 may control friction stir tool 140 to position friction stir tool 140 at one or more selected locations of substrate 120. For example, computing device 180 may control friction stir tool 140 to position friction stir tool 140 at a selected location of substrate 120, advance friction stir tool 140 while rotating friction stir tool 140 to contact surface 129 (220), penetrate at least probe 148 to a predetermined depth (260). In some examples, computing device 180 may control friction stir tool 140 to sequentially position friction stir tool 140 at a plurality of discrete or distinct locations of substrate 120. At each location, computing device may control friction stir tool 140 to advance friction stir tool 140 while rotating friction stir tool 140 to contact surface 129 (220), penetrate at least probe 148 to a predetermined depth (260). The plurality of discrete contact locations may be distributed across surface 129 of substrate 120.

In some examples, instead of positioning friction stir tool 140 at a selected location or a plurality of discrete locations across surface 129 of substrate, computing device 180 may optionally control friction stir tool 140 to traverse friction stir tool 140 along a predetermined path 127 across surface 129 of substrate 120 while substantially maintaining the predetermined depth (260), as shown in FIG. 3B. In some examples, predetermined path 127 includes at least one linear pass of friction stir tool 140 along surface 129 (260). In some examples, predetermined path 127 includes multiple linear passes, including non-intersecting or non-intersecting passes, for instance, overlapping or crossing passes.

Traversing friction stir tool 140 along predetermined path 127 (260) modifies a friction stir processed region 125 within substrate 120, as shown in FIG. 3B. In some examples, after processing is complete, friction stir processed region 125 extends to at least a subsurface region extending under at least part of or substantially the entire surface of substrate 120. Thus, in some examples, after friction stir processing according to example techniques of FIG. 2, substrate 120 may include a friction stir processed region that forms a subsurface layer over an unprocessed region that includes an unprocessed layer under the friction stir processed region, as seen in FIG. 3B. In some examples, friction stir tool 140 has a linear speed between about 0.1 inch per minute (IPM) (0.0423 mm/s) and about 10 inch per minute (IPM) (4.23 mm/s). In some examples, while traversing along predetermined path 127, rotating friction stir tool 140 has a linear speed between about 1 inch per minute (IPM) (about 0.42 mm/s) and about 4 inch per minute (IPM) (about 1.7 mm/s). In some examples, while traversing along predetermined path 127, a rotational speed of the rotating friction tool is between about 300 rpm and about 500 rpm. In some examples, a ratio of the rotational speed to the linear speed of the rotating friction tool is between about 10 rotations/mm and about 1000 rotations/mm.

FIG. 3C illustrates a cross-section of system 100 along the line A-A of FIG. 3A. As shown in FIG. 3C, in some examples, rotating friction stir tool 140 may agitate a stir region 122 of substrate 120 by inducing plastic deformation of material within stir region 122. In some examples, stir region 122, also called a nugget, extends to a region in the immediate vicinity of probe 148. Stir region 122 experiences plastic deformation, for instance, movement of softened material in the stir region. The friction from the contact of probe 148 and the plastic deformation may generate heat leading to thermal cycling in and around stir region 122. Thus, in some examples, the combination of the plastic deformation and the heat may lead to mechanical and thermal cycling in stir region 122, influencing the microstructure in stir region 122, for instance, by changes in at least one of grain size, grain boundary character, coarsening or dissolution of precipitate phase, or phase transformations within stir region 122.

In some examples, substrate 120 includes a second region, adjacent to and outside stir zone 122, that is also affected by friction stir processing using friction stir tool 140. In some examples, the second region of substrate 120 may include a thermo-mechanically affected zone (TMAZ) 124 outside and adjacent to stir region 122. Thus, in some examples, within substrate 120, TMAZ 124 may substantially surround stir region 122. While FIG. 3C shows TMAZ 124 as a relatively thin zone relative to stir region 122, in other examples, TMAZ 124 may exhibit a relatively greater thickness, a varying thickness, or both relative to stir region 122. In some examples, TMAZ 124 may experience both plastic deformation and thermal cycling that may be less intense or extensive than that experienced in stir region 122. Thus, TMAZ 124 may be a transitional zone where properties of substrate change from properties in stir region 122 to properties in outer regions of substrate 120. In some examples, TMAZ 124 may exhibit changes in microstructure similar to those described with reference to stir region 122, to a greater, similar, or lesser extent. For instance, in some examples, TMAZ 124 may exhibit grain elongation (for instance, an increase in grain size or dimension along a particular axis) and precipitate dissolution (for instance, gradual decrease in precipitate size, leading to disappearance of precipitate).

In some examples, the second region adjacent to and outside stir zone 122 within substrate 120 includes a heat affected zone (HAZ) 126 in addition to or instead of TMAZ 124. As shown in FIG. 3C, HAZ 126 may be adjacent to and outside of stir zone 122, TMAZ 124, or both. In some examples, TMAZ 124 may experience both plastic deformation and thermal cycling, while HAZ 126 may experience thermal cycling and some mechanical strain, but less than that experienced in TMAZ 124. In some examples, TMAZ 124 may be a transitional zone where properties change from stir region 122 to HAZ 126. Thus, in some examples, HAZ 126 may not experience plastic deformation, but may be affected by heat generate by the friction stir process, and therefore experience thermal cycles.

In some examples, the microstructure in HAZ 126 may exhibit changes during thermal stir processing resulting from thermal effects. For instance, in some examples, HAZ 126 may retain the same grain structure as an unprocessed region 128 within substrate 120, while exhibiting a change in the precipitate structure. In other examples, changes to the microstructure of HAZ 126 may depend at least in part on the temperature experienced by HAZ 126, the composition of substrate 120, and the pre-friction stir processing microstructure.

In some examples, unprocessed region 128 is sufficiently remote from probe 148 to be substantially unaffected (e.g., unaffected or nearly unaffected) by probe 148 at all. Further, friction stir tool 140 may contact different regions of substrate 120, and therefore, one or more of the regions or zones may overlap with regions or zones generated from a previous contact between probe 148 and substrate 120.

Thus, the properties within stir region 122, TMAZ 124, HAZ 126, and unprocessed region 128 may be affected to a varying extent depending on the location of the respective region in relation to probe 148, depending on the effects of mechanical and thermal cycles on the microstructure, as described above. The techniques described herein may be used to modify the properties (e.g., microstructure, mechanical properties, or both) of at least one of TMAZ 124 or HAZ 126, in addition to modifying the properties of stir region 122.

In some examples, the technique of FIG. 2 optionally includes disposing a first substrate 120a on a surface of a second substrate 120b, and joining the first substrate 120a and second substrate 120b using friction stir processing. In some examples, penetrating at least a portion of friction stir tool 140, such as probe 148, shoulder 146, or working end 144 to a predetermined depth below surface 129 (240) includes agitating a first stir region 122a within first substrate 120a and a second stir region 122b within second substrate 122b. In some examples, one or both of substrate 120a and substrate 120b may include metal or alloy. In some examples, one or both of substrate 120a and substrate 120b may include any suitable shape, including a flat surface, a curved surface, or an irregular surface. One or both of substrate 120a and 120b may include a metal or an alloy, as described above. In some examples, the composition of substrate 120a is substantially the same as the composition of substrate 120b. In other examples, substrate 120a has a different composition than substrate 120b. In some examples, rotating friction stir tool 140 contacts a surface of substrate 120a (220). As friction stir tool 140 penetrates first substrate 120a, rotation of friction stir tool 140 may generate at least one of stir region 122a in substrate 120a or stir region 122b in substrate 120b, and the second region may extend outside at least one of stir region 122a or stir region 122b. As shown in FIG. 3D, probe 148 may partly penetrate substrate 120a, to agitate a first stir region 122a within substrate 120a and a second stir region 122b within substrate 120b (240). The plastic deformation within at least stir region 122a or stir region 122b may join substrate 120a and substrate 120b (240). In some examples, the second region includes a third region within first substrate 120a, for instance, one or both of TMAZ 124a and HAZ 126a within substrate 120a. In some examples, the second region includes a fourth region within second substrate 120b, for instance, one or both of TMAZ 124b and HAZ 126b within substrate 120b. Thus, some example techniques may modify properties of at least one of substrate 120a and substrate 120b by modifying properties within respective stir regions or second regions, resulting in joining of substrate 120a with substrate 120b. In some examples, the region of substrate 120a joined with substrate 120b may include a first TMAZ 124a, a first HAZ 126a, and a first unprocessed region 128a. In some examples, the region of substrate 120b joined with substrate 120a may include a second TMAZ 124b, a second HAZ 126b, and a second unprocessed region 128b. In some examples, one or both of substrate 120a and 120b may include a sheet of A286 steel (for example, 0.125-inch thick), so that one or more sheets of A286 may be joined to each other or to other metals or alloys.

While FIG. 3D shows various regions of substrate 120a and 120b surrounding probe 148 in some example configurations, the regions may exhibit widely varying configurations, for instance, depending on a rotational speed, linear speed, depth, tilt, and force exhibited by friction stir tool 140 or probe 148. For example, probe 148 may fully penetrate substrate 120a, and may at least partly penetrate substrate 120b. In some examples, probe 148 may fully penetrate substrate 120a, and fully penetrate substrate 120b. Thus, in some examples, at least one of stir regions 122a and 122b, TMAZ 124a and 124b, HAZ 126a and 126b, or unprocessed regions 128a and 128b may exhibit configurations and thicknesses different from those shown in FIG. 3D.

In some examples, the example technique of FIG. 2 may optionally include aging at least one substrate 120, substrate 120a, or substrate 120b (280), before or after any of contacting 220, penetrating 240, or optionally traversing 260. In some examples, the aging includes heating one or more of substrate 120, substrate 120a, or substrate 120b to a temperate between about 1300° F. (about 704° C.) and about 1400° F. (about 760° C.) for a time between about 16 hours and about 20 hours.

As described above, the technique of FIG. 2 may change properties of a metal or an alloy of substrates 120, 120a, or 120b within various regions, including stir region 122 and at least one of TMAZ 124 or HAZ 126. For example, the technique of FIG. 2 may modify an average grain size of stir region 122 and at least one of TMAZ 124 or HAZ 126. In some examples, a pre-agitation average grain size within one or more of substrate 120, 120a, or 120b is between about 10 μm and about 60 μm. In some examples, the pre-agitation average grain size within one or more of substrate 120, 120a, or 120b is substantially equal to the average grain size within one or more of unprocessed region 128, unprocessed region 128a, or unprocessed region 128b. In some examples, a first post-agitation average grain size within one or more of stir zone 122, 122a or 122b, is between about 2 μm and about 5 μm. In some examples, a second post-agitation average grain size within at least one of the second region, the third region, the fourth region, TMAZ 124a, TMAZ 124b, HAZ 126a, or HAZ 126b, is between about 2 μm and about 15 μm or larger. The second post-agitation average grain size within the second region, the third region, the fourth region, TMAZ 124a, TMAZ 124b, HAZ 126a, or HAZ 126b may be substantially the same or may be different within different regions and zones.

As another example, the technique of FIG. 2 may modify a microhardness of stir region 122 and at least one of TMAZ 124 or HAZ 126. In some examples, a pre-agitation average microhardness of one or more of substrate 120, substrate 120a, or substrate 120b, is between about 140 Hv and about 160 Hv. In some examples, the pre-agitation microhardness within one or more of substrate 120, 120a, or 120b is substantially equal to the microhardness within one or more of unprocessed region 128, unprocessed region 128a, or unprocessed region 128b. In some examples, a first post-agitation average microhardness within one or more of stir zone 122, 122a or 122b, is between about 230 Hv and about 312 Hv. In some examples, a second post-agitation average microhardness within one or more of the second region, the third region, the fourth region, TMAZ 124a, TMAZ 124b, HAZ 126a, or HAZ126b, is between about 200 Hv and about 280 Hv. In some examples, one or both of the first post-agitation average microhardness or the second post-agitation microhardness are greater than one or more of the pre-agitation average microhardness of substrate 120, substrate 120a, or substrate 120b, or the microhardness of one or more of unprocessed region 128, unprocessed region 128a, or unprocessed region 128b.

Example friction stir processing systems and techniques described herein may reduce or substantially prevent problems associated with fusion welding or other melting-based techniques, including shrinkage, solidification, cracking and distortion. Further, metals and alloys processed by example friction processing techniques described herein may exhibit improvement in mechanical properties, for example, material microhardness and wear resistance, for instance, due to the changes in microstructure of the friction-stir-processed metal or alloy. Some example friction stir processing techniques described herein may increase a microhardness, decrease an average grain size, or both within a stir region and a second region outside and adjacent to the stir region within a metal or alloy, for instance, within austenitic superalloy A286.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer system-readable medium, such as a computer system-readable storage medium, containing instructions. Instructions embedded or encoded in a computer system-readable medium, including a computer system-readable storage medium, may cause one or more programmable processors, or other processors, to implement one or more of the techniques described herein, such as when instructions included or encoded in the computer system-readable medium are executed by the one or more processors. Computer system readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer system readable media. In some examples, an article of manufacture may comprise one or more computer system-readable storage media.

### EXAMPLES

### Example 1

The effect of traverse speed and aging on peak microhardness of friction-stir-processed A286 steel was evaluated. A friction stir tool made of PCBN was used, with a rotational speed of 400 rpm. TABLE 1 presents the traverse speed and peak microhardness, for samples with or without aging.

TABLE 1

| Traverse Speed | Peak microhardness | Peak microhardness |
|---|---|---|
| (inches per minute) | (FSP) (Hv) | (FSP + aging) (Hv) |
| 1 | 230 | 310 |
| 2 | 303 | 404 |
| 3 | 312 | 403 |
| 4 | 278 | 385 |

### Example 2

The wear rate of FSP processed and aged A-286 was compared with rolled and aged A-286. TABLE 2 presents the process condition, wear track depth, wear track area, and wear rate. The rotational speed of the tool was 400 rpm.

TABLE 2

| | Wear | Wear | |
|---|---|---|---|
| | Track Depth | Track Area | Wear Rate |
| A-286 Condition | (mm) | (mm²) | (mm³/Nm) |
| Rolled + Aged | 0.52 ± 0.13 | 44 ± 17 | 1.0 × 10⁻⁶ |
| (R + A) | | | |
| FSP + Aged (F + A) | 0.37 ± 0.05 | 110 ± 37 | 2.5 × 10⁻⁶ |
| (2 mm from top edge) | | | |
| FSP + Aged (F + A) | 0.40 ± 0.1 | 30 ± 13 | 6.94 × 10⁻⁷ |
| (4 mm from top edge) | | | |

### Example 3

The effect of traverse speed and aging on average grain size was evaluated, using a PCBN friction stir tool rotating at 400 rpm. TABLE 3 presents the traverse speed, average grain size after friction stir, and average grain size after FSP and aging.

TABLE 3

| | Average grain sige | Average grain size |
|---|---|---|
| Traverse Speed | after FSW | after FSW + aging |
| (inches per minute) | (μm) | (μm) |
| 1 | 4.9 | 1.4 |
| 2 | 2.2 | 1.5 |
| 3 | 1.8 | 1.7 |
| 4 | 2.1 | 3.3 |

### Example 4

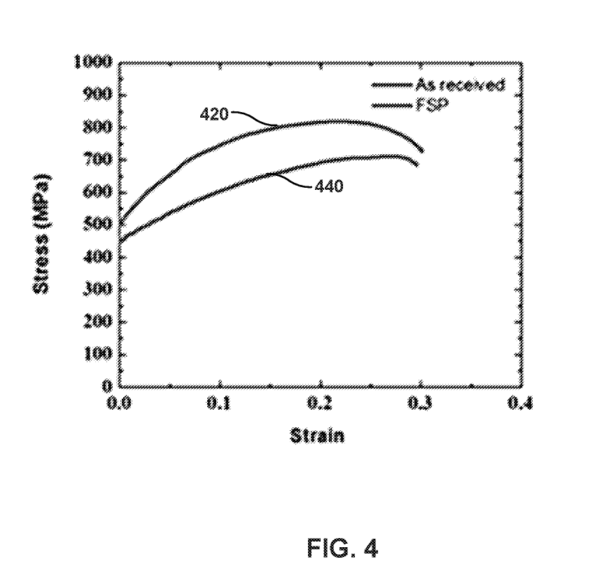

Tensile curves were measured at room temperature for as-received A286 and A286 subjected to FSP at 400 rpm and linear traverse speed of 1 inch per minute. FIG. 4 is a chart presenting a comparison of the respective stress-strain (tensile) curves. Curve 420 is a stress-strain curve for FSP processed A286, and curve 440 is a stress-strain curve for as-received (unprocessed) A286 steel.

Various examples have been described. These and other examples are within the scope of the following claims.

1. A method comprising:
contacting a surface of a substrate comprising a metal or alloy with a rotating friction stir tool; and
penetrating at least a portion of the rotating friction stir tool to a predetermined depth below the surface while rotating to agitate a stir region below the surface and modify an average grain size of the metal or alloy in the stir region and an average grain size of the metal or alloy in a second region outside of and adjacent to the stir region compared to an average grain size of the metal or alloy outside of the stir region and the second region to modify a microhardness of the metal or alloy in the stir region and a microhardness of the metal or alloy in the second region compared to a microhardness of the metal or alloy outside of the stir region and the second region.

2. The method of claim 1, wherein contacting the surface of the substrate with the rotating friction stir tool comprises contacting the surface of the substrate with the rotating friction stir tool at a plurality of discrete contact locations distributed across the surface of the substrate.

3. The method of claim 1, wherein the second region comprises at least one of a heat affected zone or a thermo-mechanically affected zone of the substrate.

4. The method of claim 1, further comprising traversing the friction stir tool along a predetermined path across the surface of the substrate while substantially maintaining the predetermined depth.

5. The method of claim 4, wherein the predetermined path comprises at least one linear pass of the friction stir tool.

6. The method of claim 1, wherein the substrate comprises a first substrate, the method further comprising:
disposing the substrate on a surface of a second substrate comprising a metal or alloy, wherein penetrating at least the portion of the rotating friction stir tool to a predetermined depth below the surface while rotating to agitate a stir region below the surface comprises agitating a first stir region within the first substrate and a second stir region within the second substrate.

7. The method of claim 6, wherein penetrating at least the portion of the rotating friction stir tool to the predetermined depth below the surface while rotating to agitate the stir region below the surface joins the first substrate and the second substrate.

8. The method of claim 6, wherein the second region comprises a third region within the first substrate and a fourth region within the second substrate.

9. The method of claim 1, wherein the metal or alloy comprises an iron-based or a nickel-based alloy.

10. The method of claim 9, wherein the metal or alloy comprises an austenitic phase constitution.

11. The method of claim 10, wherein the metal or alloy substrate comprises an iron-based alloy comprising between about 24% and about 27% by weight of nickel, between about 13.5% and about 16% by weight of chromium, between about 1% and about 1.5% by weight of molybdenum, between about 1.9% and about 2.35% by weight of titanium, between about 0.1% and about 0.5% by weight of vanadium, between about 0.003% and about 0.01% by weight of boron, up to about 0.08% by weight of carbon, up to about 2% by weight of manganese, up to about 1% by weight of silicon, up to about 0.025% by weight of phosphorus, up about 0.025% by weight of sulfur, up about 0.35% by weight of aluminum, and a balance iron.

12. The method of claim 1, wherein the rotating friction tool has a rotational speed between about 50 rpm and about 1000 rpm.

13. The method of claim 4, wherein the rotating friction tool has a linear speed between about 0.0423 mm/s and about 4.23 mm/s.

14. The method of claim 13, wherein a ratio of the rotational speed to the linear speed of the rotating friction tool is between about 10 rotations/mm and about 1000 rotations/mm.

15. The method of claim 1, wherein the penetrating at least the portion of the rotating friction stir tool to the predetermined depth below the surface while rotating to agitate the stir region below the surface reduces the average grain size of the metal or alloy in the stir region and the average grain size of the metal or alloy in the second region compared to the average grain size of the metal or alloy outside the stir region and the second region.

16. The method of claim 1, wherein the penetrating at least the portion of the rotating friction stir tool to the predetermined depth below the surface while rotating to agitate the stir region below the surface increases the microhardness of the metal or alloy in the stir region and the microhardness of the metal or alloy in the second region compared to the microhardness of the metal or alloy outside the stir region and the second region.

17. An article comprising iron-based alloy substrate, the iron-based alloy substrate comprising:
between about 24% and about 27% by weight of nickel, between about 13.5% and about 16% by weight of chromium, between about 1% and about 1.5% by weight of molybdenum, between about 1.9% and about 2.35% by weight of titanium, between about 0.1% and about 0.5% by weight of vanadium, between about 0.003% and about 0.01% by weight of boron, up to about 0.08% by weight of carbon, up to about 2% by weight of manganese, up to about 1% by weight of silicon, up to about 0.025% by weight of phosphorus, up to about 0.025% by weight of sulfur, up to about 0.35% by weight of aluminum, and a balance of iron; and
a friction stir processed region, the friction stir processed region comprising a stir region and a second region outside of and adjacent to the stir region, wherein a first average grain size in the stir region and a second average grain size in the second region are modified compared to a pre-friction stir average grain size of the iron-based alloy substrate and a first microhardness in the stir region and a second microhardness in the second region are modified compared to a pre-friction stir microhardness of the iron-based alloy substrate.

18. The article of claim 17, further comprising a second metal or alloy substrate joined to the iron-based alloy substrate by friction stir processing.

19. A computer readable storage medium comprising instructions that, when executed, cause at least one processor to:
control a friction stir tool to contact a surface of a substrate comprising a metal or alloy, and rotate; and
control the friction stir tool to penetrate at least a portion of the friction stir tool below the surface to a predetermined depth while rotating to agitate a stir region below the surface; wherein the agitating modifies an average grain size of the metal or alloy in the stir region and an average grain size of the metal or alloy in a second region outside of and adjacent to the stir region compared to an average grain size of the metal or alloy substrate outside of the stir region and the second region to modify a microhardness of the metal or alloy substrate in the stir region and a microhardness of the metal or alloy substrate in the second region compared to a microhardness of the metal or alloy substrate outside of the stir region and the second region.

20. The computer readable storage medium of claim 19, further comprising instructions that, when executed, cause the at least one processor to:
control the friction stir tool to traverse along a predetermined path across the metal surface while substantially maintaining the predetermined depth.
